(19) United States
(12) Patent Application Publication
(10) Pub. No.: US 2010/0289896 A1
(43) Pub. Date: Nov. 18, 2010

(54) High Definition Speed Dome Camera with Internal Wireless Video Transmission

(75) Inventor: Ya Jun KONG, Shenzhen (CN)

Correspondence Address: DAVID AND RAYMOND PATENT FIRM, 108 N. YNEZ AVE., SUITE 128, MONTEREY PARK, CA, 91754, US

(73) Assignee: SHENZHEN INFINOVA LIMITED, Shenzhen (CN)

(21) Appl. No.: 12/581,815

(22) Filed: Oct. 19, 2009

(30) Foreign Application Priority Data
May 15, 2009 (CN) 200920131758.3

(51) Int. Cl. H04N 7/18

(52) U.S. Cl. 348/143; 348/E07.085

(57) ABSTRACT

A speed dome camera includes a stationary unit, a moving unit rotatably mounted to the stationary unit, and a wireless signal transmission module. The stationary unit includes a mounting base and a signal processing module supported at the mounting base. The moving unit includes an image capturer and a controller module operatively linked to the image capturer, wherein the image capturer is adapted for obtaining an image signal when the image capturer is rotating. The wireless signal transmission module is operatively linking the stationary unit with the moving unit for wirelessly transmitting the image signal from the image capturer to the signal processing module. Therefore, the high definition image signal is able to be wirelessly transmitted from the image capturer to the signal processing module while the moving unit is rotating at its maximum rotational speed of 400 degrees per second without affecting an image quality during wireless transmission.

### BACKGROUND OF THE PRESENT INVENTION

1. Field of Invention

The present invention relates to a high definition speed dome camera, and more particularly to a high definition speed dome camera with an internal wireless video transmission.

2. Description of Related Arts

Speed dome camera is one of the most important front end equipment of the security monitoring system. The principle of the speed dome camera is through continuous high speed rotation of a lens seat to drive the lens to rotate so as to capture the image of a wide range area under surveillance. Generally speaking, the lens seat is needed for 360° continuous rotation, wherein the rotational speed of the lens seat is bout 250 to 300 degree per second. Once the video image is captured by the lens in a high rotational speed manner, the video image will be send to the stationary control circuit. Therefore, the video image can be transmitted to the control center or other destinations through an external cable.

The signal communication of the speed dome camera between the rotatable component, such as the lens seat, and the stationary component, such as the control circuit, is established by a slip ring which can be generally categorized into an electric slip ring and an optical slip ring. The electric slip ring generally comprises a conductive ring and an electric brush, wherein the working principle of the electric slip ring is that one of the conductive ring and the electric brush must be set in a stationary manner while another one is fixed to the rotatable component. Therefore, the conductive ring and the electric brush will keep in contact with each other during the relative rotational movement therebetween, so as to maintain the electrical connection between the conductive ring and the electric brush. Due to the relatively small space of the slip ring with a high compactness of wiring, the mutual inductance and capacity of the signal and the electrical coupling thereof through the wiring will be exceptionally serious. In addition, interference is created between the driving power and the signal. Therefore, the bandwidth, transmission speed, and signal quality of the slip ring will be limited. In order to maintain the high quality of the signal, the rotatable component cannot be adjusted to its maximum rotational speed. In other words, the electric slip ring cannot handle the transmission of high definition signal when high reliability and low signal distortion is required. The optical slip ring can achieve high speed, wide bandwidth, and better signal quality for transmission. However, the manufacturing cost of the speed dome camera incorporating with the optical slip ring will be relatively high.

### SUMMARY OF THE PRESENT INVENTION

A main object of the present invention is to solve the above mentioned problems. The present invention provides a high definition speed dome camera which comprises a wireless signal transmission module for wirelessly transmit the signal between the moving unit and the stationary unit in a high speed, wide bandwidth, and low signal distortion manner. Accordingly, high reliability of signal transmission for the speed dome camera can be achieved with the core element being rotated up to 400 degree per second.

Accordingly, in order to accomplish the above objects, the present invention provides a high definition speed dome camera which comprises a moving unit comprising a core element, and a stationary unit comprising an outer casing and a mounting base received in the outer casing. The core element is rotatably mounted to the mounting base and is adapted to rotate in a 360° manner, wherein the core element comprises a high definition image capturer and a controller module operatively linked to the image capturer. The high definition speed dome camera further comprises a signal processing module supported at the mounting base to communicate with the controller module though the slip ring.

The high definition speed dome camera further comprises a wireless signal transmission module which comprises a wireless transmitter built-in with the moving unit to operatively link to the image capturer of the core element, and a wireless receiver which is built-in with the stationary unit and is supported at the mounting base to operatively link to the signal processing module. When the image capturer obtains a high definition image signal, the wireless transmitter will convert the image signal into a wireless signal for wirelessly transmitting to the wireless receiver. Once the wireless receiver receives the wireless signal and reverts back to the high definition image signal, the image signal will then be sent to the signal processing module.

Compared with the existing technology, the speed dome camera of the present invention incorporates with the wireless signal transmission module to prevent the slip ring, which is an electric slip ring, on the effect of signal quality, especially video signal, and to enhance the signal transmission with high speed, wide bandwidth, low signal distortion, and high reliability. In addition, the manufacturing cost of the speed dome camera will be substantially reduced. The rotational speed of the core element of the present invention is higher than that of the conventional speed dome camera, wherein the core element is adapted to adjust its rotational speed up to 400 degree per second

These and other objectives, features, and advantages of the present invention will become apparent from the following detailed description, the accompanying drawings, and the appended claims.

### BRIEF DESCRIPTION OF THE DRAWINGS

FIG. 1 is a block diagram of the speed dome camera with an internal wireless signal transmission module according to a preferred embodiment of the present invention.

### DETAILED DESCRIPTION OF THE PREFERRED EMBODIMENT

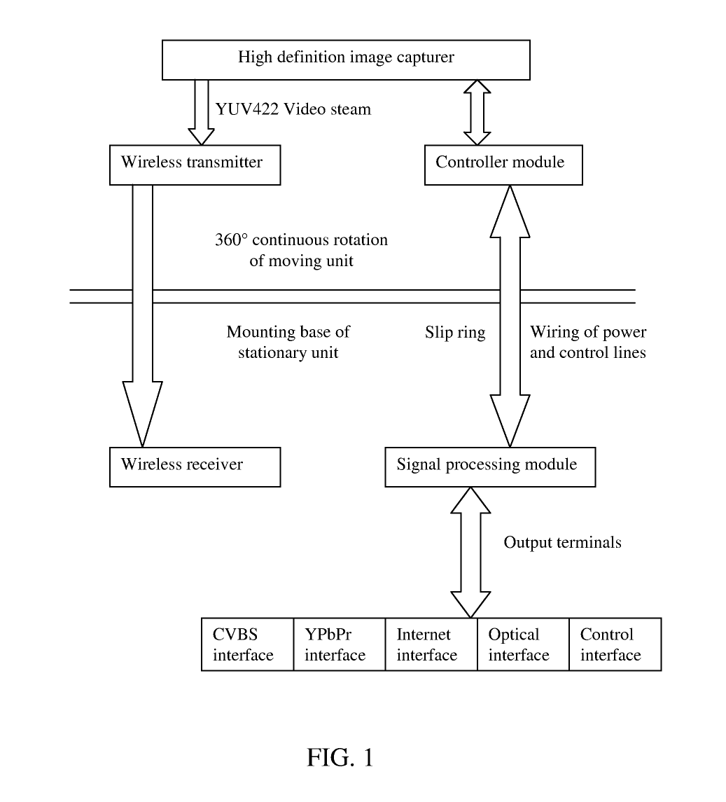

As shown in FIG. 1, a speed dome camera with an internal wireless signal transmission is illustrated, wherein the speed dome camera comprises a core element and an outer casing. The core element comprises an electric motor, a high definition image capturer, such as a camera, and a controller module, wherein the core element is driven to rotate 360° via the electric motor such that the image capturer is adapted to capture a high definition image during the revolution. A mounting base is received in the outer casing, wherein a signal processing module, CVBS interface, YPbPr interface, Internet interface, optical interface, control interface, and power outlet are provided at the mounting base. Accordingly, the interfaces are correspondingly connected through wires to communicatively link to an external source. Within the interior of the speed dome camera, the power source, the control signal, and other connection, which have strong anti-interference ability, are communicatively linked together through the slip ring, preferably an electric slip ring, between the controller module of the core element and the signal processing module at the mounting base. In order to transmit the high definition image (video) signal, the speed dome camera further comprises a wireless signal transmission module built-in therewith, wherein the wireless signal transmission module comprises a wireless transmitter operatively linked to the core element and a wireless receiver operatively mounted at the mounting base to wirelessly communicate with the wireless transmitter. Accordingly, the wireless transmitter is operatively linked to the image capturer, wherein when the image capturer obtains the high definition image signal, the image signal is sent to the wireless transmitter. Then, the wireless transmitter will convert the image signal into a wireless signal to wirelessly transmit to the wireless receiver. After the wireless receiver receives the wireless signal and revert back to the high definition image signal, the image signal will be sent to the signal processing module, such that the signal processing module will process the image signal for further modification before outputting the image signal.

According to the present invention, the speed dome camera is able to transmit the high definition image (video) signal, which is a non-compressed data format, from the moving unit to the stationary unit with high speed, wide bandwidth, low signal distortion, and high reliability. The maximum transfer rate of the image signal through the wireless signal transmission module can be 30 frames per second to be transmitted in an uncompressed 1080 p video streaming manner. Excluding the effect of the slip ring, the moving element of the speed dome camera is adapted to increase its rotational speed at 400 degrees per second without affecting the image (video) quality. When an external wireless transceiver module is provided, the wireless signal transmission module of the present invention is adapted to wirelessly communicate with the external wireless transceiver through the encryption arrangement.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A speed dome camera, comprising:
a stationary unit which comprises an outer casing, a mounting base received in said outer casing, and a signal processing module supported at said mounting base;
a moving unit, which is rotatably mounted to said stationary unit, comprising an image capturer and a controller module operatively linked to said image capturer, wherein said image capturer is adapted for obtaining an image signal when said image capturer is rotating with respect to said stationary unit; and
a wireless signal transmission module operatively linking said stationary unit with said moving unit for wirelessly transmitting said image signal from said image capturer to said signal processing module.

2. The speed dome camera, as recited in claim 1, wherein said wireless signal transmission module comprises a wireless transmitter supported at said moving unit to operatively link to said image capturer for receiving an image signal obtained by said image capturer and for converting said image signal into a wireless signal, and a wireless receiver mounted at said mounting base to operatively link to said signal processing module, wherein said wireless receiver receives said wireless signal from said wireless transmitter and reverts said wireless signal back to said image signal to be sent to said signal processing module.

3. The speed dome camera, as recited in claim 1, wherein said image signal is a non-compressed data format to be wirelessly transmitted from said image capturer to said signal processing module.

4. The speed dome camera, as recited in claim 2, wherein said image signal is a non-compressed data format to be wirelessly transmitted from said image capturer to said signal processing module.

5. The speed dome camera, as recited in claim 3, wherein said wireless signal transmission module has a maximum transfer rate of said image signal at 30 frames per second.

6. The speed dome camera, as recited in claim 4, wherein said wireless signal transmission module has a maximum transfer rate of said image signal at 30 frames per second.

7. The speed dome camera, as recited in claim 1, wherein said moving unit is rotatably mounted to said stationary unit through an electric slip ring that allows said moving unit being rotated 360° in a high speed manner.

8. The speed dome camera, as recited in claim 4, wherein said moving unit is rotatably mounted to said stationary unit through an electric slip ring that allows said moving unit being rotated 360° in a high speed manner.

9. The speed dome camera, as recited in claim 7, wherein said moving unit has a maximum rotational speed of 400 degrees per second without affecting an image quality during wireless transmission.

10. The speed dome camera, as recited in claim 7, wherein said moving unit has a maximum rotational speed of 400 degrees per second without affecting the image quality during wireless transmission.

11. The speed dome camera, as recited in claim 1, wherein said image capturer is a high definition camera adapted for obtaining a high definition video signal as said image signal.

12. The speed dome camera, as recited in claim 8, wherein said image capturer is a high definition camera adapted for obtaining a high definition video signal as said image signal.

13. A method for internally transmitting an image signal of a speed dome camera which comprises a moving unit, a stationary unit, and a wireless signal transmission module, comprising the steps of:
(a) obtaining said image signal by an image capturer of said moving unit, wherein said image capturer is rotated in a high speed manner while image capturing;
(b) wirelessly transmitting said image signal from a wireless transmitter to a wireless receiver of said wireless signal transmission module, wherein said wireless transmitter is built-in with said moving unit to operatively link to said image capturer while said wireless receiver is built-in with said stationary unit; and
(c) sending said image signal from said wireless receiver to a signal processing module of said stationary unit.

14. The method as recited in claim 13, before the step (b), further comprising a step of converting said image signal into a wireless signal through said wireless transmitter so as to wirelessly transmit said wireless signal to said wireless receiver.

15. The method as recited in claim 14, before the step (c), further comprising a step of reverting said wireless signal back to said image signal through said wireless receiver so as to send said image signal to said signal processing module.

16. The method as recited in claim 15 wherein, in the step (b), said image signal is a non-compressed data format to be wirelessly transmitted from said image capturer to said signal processing module through said wireless signal transmission module.

17. The method, as recited in claim 16, wherein said wireless signal transmission module has a maximum transfer rate of said image signal at 30 frames per second.

18. The method, as recited in claim 15, wherein said moving unit is rotatably mounted to said stationary unit through an electric slip ring that allows said moving unit being rotated 360° in a high speed manner.

19. The method, as recited in claim 18, wherein said moving unit has a maximum rotational speed of 400 degrees per second without affecting an image quality during wireless transmission.

20. The method, as recited in claim 15, wherein said image capturer is a high definition camera adapted for obtaining a high definition video signal as said image signal.
